(19) United States
(12) Patent Application Publication
(10) Pub. No.: US 2017/0074896 A1
(43) Pub. Date: Mar. 16, 2017

(54) PHYSICAL QUANTITY SENSOR, ELECTRONIC APPARATUS, AND MOVING OBJECT

(71) Applicant: Seiko Epson Corporation, Tokyo (JP)

(72) Inventors: Satoru TANAKA, Chino (JP); Shota KIGURE, Takasaki (JP)

(21) Appl. No.: 15/188,230

(22) Filed: Jun. 21, 2016

(30) Foreign Application Priority Data
Jul. 10, 2015 (JP) 2015-138778

(51) Int. Cl. G01P 1/00; G01P 15/125

(52) U.S. Cl. CPC G01P 1/006; G01P 15/125

(57) ABSTRACT

A physical quantity sensor according to the invention includes a first movable electrode portion having a portion that is opposed to a first fixed electrode portion, and a second movable electrode portion having a portion that is opposed to a second fixed electrode portion. The physical quantity sensor further includes a movable mass portion that has a shape surrounding a first fixed electrode side fixing portion and a second fixed electrode side fixing portion in a plan view, and a first movable electrode side fixing portion and a second movable electrode side fixing portion that support the movable mass portion via a first elastic portion and a second elastic portion and are disposed at the outside of the movable mass portion in a plan view.

### BACKGROUND

1. Technical Field

The present invention relates to a physical quantity sensor, an electronic apparatus, and a moving object.

2. Related Art

In recent years, a sensor manufactured by using a silicon Micro Electro Mechanical System (MEMS) technique has been developed. As such a sensor, a capacitive-type physical quantity sensor has been known (for example, refer to JP-A-10-111312), the capacitive-type physical quantity sensor including fixed electrodes fixedly disposed and movable electrodes which are opposed to the fixed electrodes with a distance therebetween and provided so as to be displaceable, and detecting a physical quantity such as acceleration, angular velocity, or the like based on the capacitance between the two electrodes.

For example, a physical quantity sensor disclosed in JP-A-10-111312 includes two mounting bars fixed to the surface of the substrate by using two anchor coupling regions, two flexure springs respectively fixed to each of the mounting bars, one center bar coupled to the other end of the total of four flexure springs, a plurality of movable electrodes mounted to the center bar, and a plurality of fixed electrodes that are fixed to the surface of the substrate by using a plurality of anchor coupling regions and disposed to be opposed to each of the plurality of the movable electrodes.

In the physical quantity sensor in the related art, the fixed electrodes are connected and fixed to the substrate by using a plurality of connection portions (anchor coupling regions disclosed in JP-A-10-111312). However, a part of the movable electrodes (center bar disclosed in JP-A-10-111312) is positioned between two connection portions of the plurality of connection portions in a plan view. For this reason, in the physical quantity sensor in the related art, it is difficult to shorten the distance between the two connection portions. For example, when the substrate is warped due to a change in temperature, the fixed electrodes are influenced by the warpage of the substrate via the connection portions, and thus the fixed electrodes are likely to be distorted. As a result, there is a problem that temperature characteristics of the physical quantity sensor deteriorate. Here, the warpage of the substrate due to a change in temperature, for example, is caused by a difference in linear expansion coefficient between the substrate and a member (for example, a structure body including the movable electrodes and the fixed electrodes, or a lid member constituting a package in which the substrate and the structure body are accommodated) bonded to the substrate.

### SUMMARY

An advantage of some aspects of the invention is to provide a physical quantity sensor having excellent characteristics and provide an electronic apparatus and a moving object including the physical quantity sensor.

The advantage is achieved by the invention described below.

A physical quantity sensor according to an aspect of the invention includes: a first fixed electrode side fixing portion including a first fixed electrode portion; a second fixed electrode side fixing portion including a second fixed electrode portion; a movable mass portion that includes a first movable electrode portion having a portion which is opposed to the first fixed electrode portion and a second movable electrode portion having a portion which is opposed to the second fixed electrode portion, and that has a shape surrounding the first fixed electrode side fixing portion and the second fixed electrode side fixing portion in a plan view; a first movable electrode side fixing portion and a second movable electrode side fixing portion that are disposed at the outside of the movable mass portion in a plan view; a first elastic portion connecting the first movable electrode side fixing portion and a portion of one end side of the movable mass portion in a first direction so as to allow the movable mass portion to be displaced in the first direction; and a second elastic portion connecting the second movable electrode side fixing portion and a portion of the other end side of the movable mass portion in the first direction so as to allow the movable mass portion to be displaced in the first direction.

According to the physical quantity sensor, in a plan view, the movable mass portion has a frame shape, and the two fixed electrode side fixing portions (the first fixed electrode side fixing portion and the second fixed electrode side fixing portion) are disposed at the inside of the movable mass portion. Thus, it is possible to shorten the distance between the two fixed electrode side fixing portions (more specifically, the distance between portions at which the two fixed electrode side fixing portions are connected to the substrate). Therefore, even in a case where the substrate to which the fixed electrode side fixing portions are fixed is warped due to a change in temperature, the fixed electrode portions can be less distorted by the warpage of the substrate. As a result, the physical quantity sensor can have excellent temperature characteristics.

In addition, in a plan view, the two movable electrode side fixing portions (the first movable electrode side fixing portion and the second movable electrode side fixing portion), the first elastic portion, and the second elastic portion are disposed at the outside of the movable mass portion. Thus, it is possible to increase the degree of freedom of arrangement of the two movable electrode side fixing portions. As a result, it is possible to stably support the movable mass portion. Particularly, a portion of one end side of the movable mass portion in the first direction (detection axis direction) is supported by the first elastic portion, and a portion of the other end side of the movable mass portion in the first direction is supported by the second elastic portion. Thus, unnecessary vibration mode of the movable mass portion (for example, vibration mode of a rotation system) is reduced. As a result, it is possible to improve accuracy of detection characteristics.

As described above, it is possible to provide a physical quantity sensor having excellent characteristics.

In the physical quantity sensor according to the aspect of the invention, it is preferable that the first movable electrode portion includes a plurality of first movable electrode fingers extended along a second direction intersecting with the first direction, that the second movable electrode portion includes a plurality of second movable electrode fingers extended along the second direction, that the first fixed electrode portion includes a plurality of first fixed electrode fingers extended along the second direction, and that the second fixed electrode portion includes a plurality of second fixed electrode fingers extended along the second direction.

In this case, it is possible to increase a change in capacitance between the first fixed electrode portion and the first movable electrode portion, and a change in capacitance between the second fixed electrode portion and the second movable electrode portion, in accordance with the displacement of the movable mass portion. Therefore, it is possible to improve the sensitivity of the physical quantity sensor.

In the physical quantity sensor according to the aspect of the invention, it is preferable that the first fixed electrode side fixing portion includes a first extension portion that is extended along the first direction and supports the plurality of the first fixed electrode fingers, and that the second fixed electrode side fixing portion includes a second extension portion that is extended along the first direction and supports the plurality of the second fixed electrode fingers.

In this case, it is possible to efficiently increase the number of the fixed electrode fingers and the movable electrode fingers. Therefore, it is possible to further increase a change in capacitance between the first fixed electrode portion and the first movable electrode portion, and a change in capacitance between the second fixed electrode portion and the second movable electrode portion, in accordance with the displacement of the movable mass portion.

In the physical quantity sensor according to the aspect of the invention, it is preferable that the first fixed electrode side fixing portion and the second fixed electrode side fixing portion are disposed side by side along the first direction, that the first extension portion is extended toward the opposite side of the second fixed electrode side fixing portion, and that the second extension portion is extended toward the opposite side of the first fixed electrode side fixing portion.

In this case, it is possible to efficiently reduce noise by a differential operation of a signal due to the change in capacitance between the first fixed electrode portion and the first movable electrode portion, and a signal due to the change in capacitance between the second fixed electrode portion and the second movable electrode portion. In addition, the first fixed electrode side fixing portion and the second fixed electrode side fixing portion are disposed side by side along the first direction, and thus, when the substrate to which the fixed electrode side fixing portions and the movable electrode side fixing portions are fixed is warped in the second direction intersecting with the first direction, the fixed electrode portions and the movable electrode portions can be effectively less affected by the warpage of the substrate.

In the physical quantity sensor according to the aspect of the invention, it is preferable that the first fixed electrode side fixing portion and the second fixed electrode side fixing portion are disposed side by side along the second direction intersecting with the first direction, that the first extension portion includes a portion extended to one side in the first direction, and that the second extension portion includes a portion extended to the other side in the first direction.

In this case, it is possible to efficiently reduce noise by a differential operation of a signal due to the change in capacitance between the first fixed electrode portion and the first movable electrode portion, and a signal due to the change in capacitance between the second fixed electrode portion and the second movable electrode portion. In addition, the first fixed electrode side fixing portion and the second fixed electrode side fixing portion are disposed side by side along the second direction, and thus, when the substrate to which the fixed electrode side fixing portions and the movable electrode side fixing portions are fixed is warped in the first direction, the fixed electrode portions and the movable electrode portions can be effectively less affected by the warpage of the substrate.

In the physical quantity sensor according to the aspect of the invention, it is preferable that each of the first extension portion and the second extension portion includes two portions extended to one side and the other side in the first direction.

In this case, it is possible to improve impact resistance against vibration in the second direction. In addition, it is possible to configure the physical quantity sensor with an excellent symmetric shape, and efficiently increase the number of the fixed electrode fingers.

In the physical quantity sensor according to the aspect of the invention, it is preferable that the movable mass portion includes weight portions which are extended toward the inside of the movable mass portion in a plan view, between the two first movable electrode fingers, between the two second movable electrode fingers, or between the first movable electrode fingers and the fixed electrode fingers, and which have a wider width than the width of the first movable electrode fingers or the second movable electrode fingers.

In this case, it is possible to increase the mass of the movable mass portion and increase the area of the movable mass portion toward the center of the physical quantity sensor. As a result, it is possible to reduce the displacement of the movable mass portion, for example, due to external vibration (for example, in-plane rotation), and improve the sensitivity of the physical quantity sensor.

It is preferable that the physical quantity sensor according to the aspect of the invention further includes: a substrate; a first fixed electrode side wiring that is provided in the substrate and electrically connected to the first fixed electrode fingers; and a second fixed electrode side wiring that is provided in the substrate and electrically connected to the second fixed electrode fingers, in which the first extension portion includes a portion overlapped with the first fixed electrode side wiring in a plan view, and in which the second extension portion includes a portion overlapped with the second fixed electrode side wiring in a plan view.

In this case, the extension portions and the fixed electrode side wirings have the same potential with each other. Thus, by overlapping the extension portions with the fixed electrode side wirings in a plan view, it is possible to reduce parasitic capacitance generated between the substrate and the extension portions. As a result, the physical quantity sensor can have excellent detection characteristics.

It is preferable that the physical quantity sensor according to the aspect of the invention further includes: a substrate; and movable electrode side wirings that are provided in the substrate and electrically connected to each of the first movable electrode fingers and the second movable electrode fingers, in which each of tips of the first movable electrode fingers and the second movable electrode fingers overlaps with the movable electrode side wirings in a plan view.

In this case, when a structure body including the movable electrode side fixing portions is bonded to the substrate by using anode bonding, the tips of the movable electrode fingers are opposed to the movable electrode side wirings having the same potential as that of the tips of the movable electrode fingers. Thus, electric field generated between the tips of the movable electrode fingers and the substrate is reduced, as a result, it is possible to prevent or reduce adherence of each of the movable electrode fingers to the substrate.

It is preferable that the physical quantity sensor according to the aspect of the invention further includes: a substrate; and movable electrode side wirings provided in the substrate, in which at least one fixing portion of the first movable electrode side fixing portion and the second movable electrode side fixing portion includes a plurality of connection portions connected to the movable electrode side wirings.

In this case, the first movable electrode side fixing portion and the second movable electrode side fixing portion have the same potential with each other. Thus, electrical contact between the structure body including the first movable electrode side fixing portion and the second movable electrode side fixing portion and the movable electrode side wirings can be made at a plurality of positions. Therefore, it is possible to improve reliability of the contact.

It is preferable that the physical quantity sensor according to the aspect of the invention further includes: contact portions with conductivity that are provided between the connection portions and the movable electrode side wirings, being in contact with the connection portions and the movable electrode side wirings.

In this case, it is possible to improve reliability of the electrical contact between the structure body and the movable electrode side wirings, the structure body including the first movable electrode side fixing portion and the second movable electrode side fixing portion that have the same potential with each other.

It is preferable that the physical quantity sensor according to the aspect of the invention further includes: protrusion portions that overlap with the movable mass portion in a plan view and are provided on the main face of the substrate.

In this case, it is possible to regulate the movement of the movable mass portion in an out-of-plane direction by the protrusion portions. As a result, it is possible to prevent or reduce adherence of the movable mass portion to the substrate.

In the physical quantity sensor according to the aspect of the invention, it is preferable that the movable mass portion includes weight portions that are extended toward the inside of the movable mass portion in a plan view.

In this case, it is possible to increase the mass of the movable mass portion and increase the area of the movable mass portion toward the center of the physical quantity sensor. As a result, it is possible to reduce the displacement of the movable mass portion, for example, due to external vibration (for example, in-plane rotation), and improve the sensitivity of the physical quantity sensor.

It is preferable that the physical quantity sensor according to the aspect of the invention further includes: a substrate to which the first movable electrode side fixing portion and the second movable electrode side fixing portion are fixed, in which the length in the second direction of a portion in which each of the first movable electrode side fixing portion and the second movable electrode side fixing portion is fixed to the substrate is shorter than the length of the movable mass portion in the second direction.

In this case, it is possible to reduce a bonding area between the movable electrode side fixing portions and the substrate to which the movable electrode side fixing portions are fixed. Therefore, it is possible to reduce stress transmitted from the substrate to the structure body including the movable electrode side fixing portions.

It is preferable that the physical quantity sensor according to the aspect of the invention further includes: a stopper that is provided on at least one of the first movable electrode side fixing portion and the second movable electrode side fixing portion, and regulates the amount of displacement of the movable mass portion in at least one direction of the first direction and the second direction.

In this case, unintentional displacement of the movable mass portion in in-plane direction is reduced, and as a result, it is possible to improve impact resistance of the physical quantity sensor.

An electronic apparatus according to another aspect of the invention includes the physical quantity sensor according to the aspect of the invention.

According to the electronic apparatus, the physical quantity sensor has excellent characteristics, and thus it is possible to improve reliability of the electronic apparatus.

A moving object according to still another aspect of the invention includes the physical quantity sensor according to the aspect of the invention.

According to the moving object, the physical quantity sensor has excellent characteristics, and thus it is possible to improve reliability of the moving object.

### BRIEF DESCRIPTION OF THE DRAWINGS

The invention will be described with reference to the accompanying drawings, wherein like numbers reference like elements.

FIG. 1 is a plan view illustrating a physical quantity sensor according to a first embodiment of the invention.

FIG. 2 is a sectional view taken along line II-II of the physical quantity sensor illustrated in FIG. 1.

FIG. 3 is a sectional view taken along line III-III of the physical quantity sensor illustrated in FIG. 1.

FIG. 4 is an enlarged plan view of a portion for explaining a first fixed electrode portion, a first movable electrode portion, and a first elastic portion included in the physical quantity sensor illustrated in FIG. 1.

FIG. 5 is a plan view for explaining a support substrate and a wiring pattern included in the physical quantity sensor illustrated in FIG. 1.

FIG. 6 is a plan view illustrating a physical quantity sensor according to a second embodiment of the invention.

FIG. 7 is a plan view illustrating a physical quantity sensor according to a third embodiment of the invention.

FIG. 8 is a plan view illustrating a physical quantity sensor according to a fourth embodiment of the invention.

FIG. 9 is a perspective view schematically illustrating a configuration of a mobile type personal computer serving as an example of an electronic apparatus of the invention.

FIG. 10 is a perspective view schematically illustrating a configuration of a mobile phone serving as an example of the electronic apparatus of the invention.

FIG. 11 is a perspective view illustrating a configuration of a digital still camera serving as an example of the electronic apparatus of the invention.

FIG. 12 is a perspective view illustrating a configuration of a vehicle serving as an example of a moving object of the invention.

### DESCRIPTION OF EXEMPLARY EMBODIMENTS

Hereinafter, a physical quantity sensor, an electronic apparatus, a moving object according to the invention will be described in detail based on preferred embodiments illustrated in the accompanying drawings.

### 1. Physical Quantity Sensor

First, a physical quantity sensor according to the invention will be described.

### First Embodiment

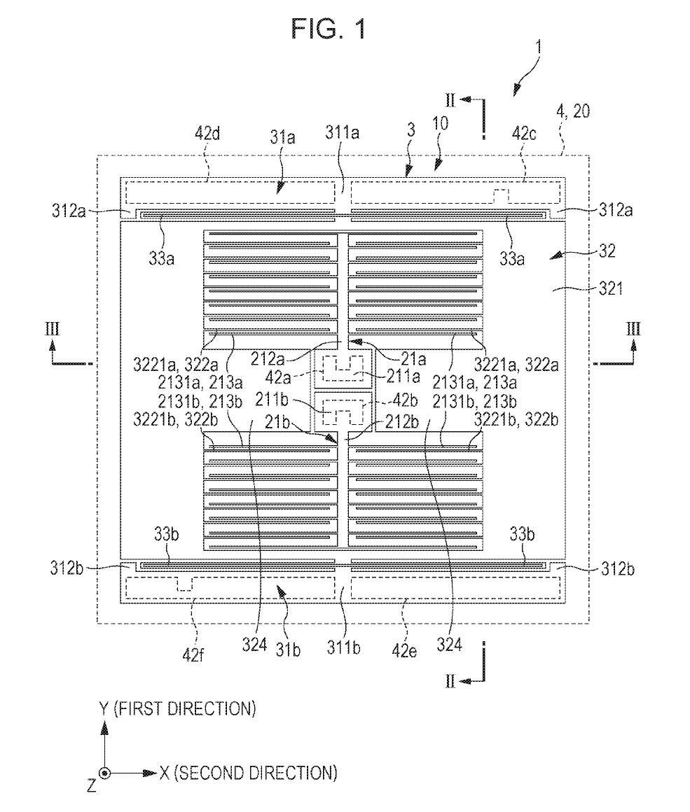

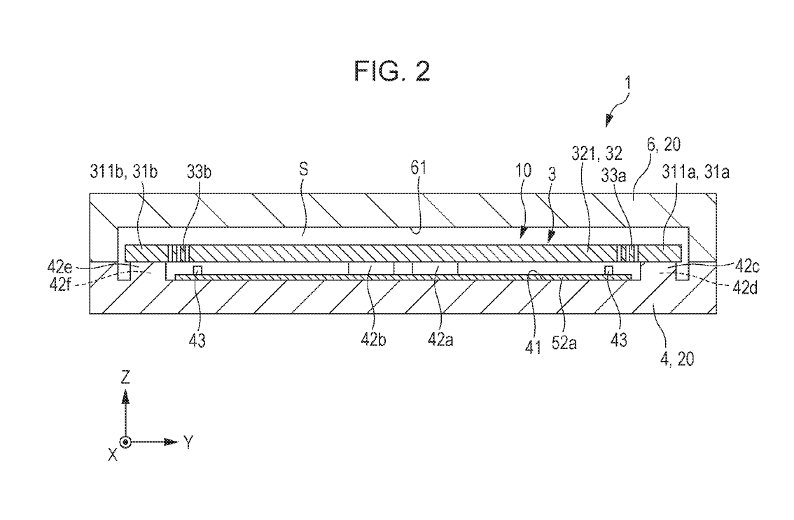

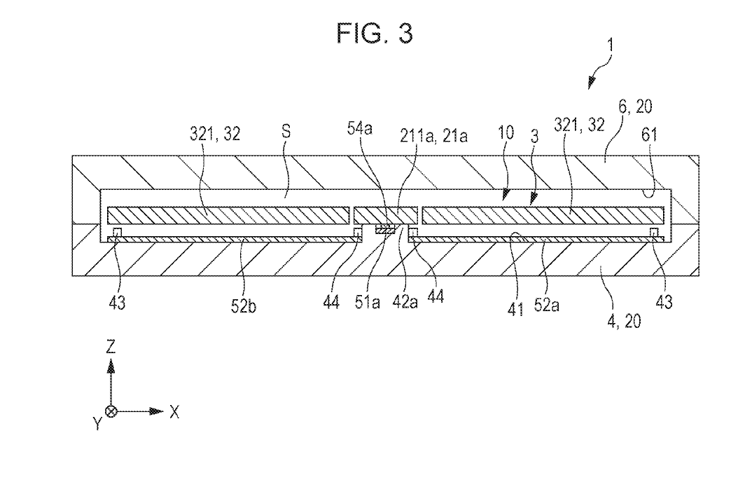

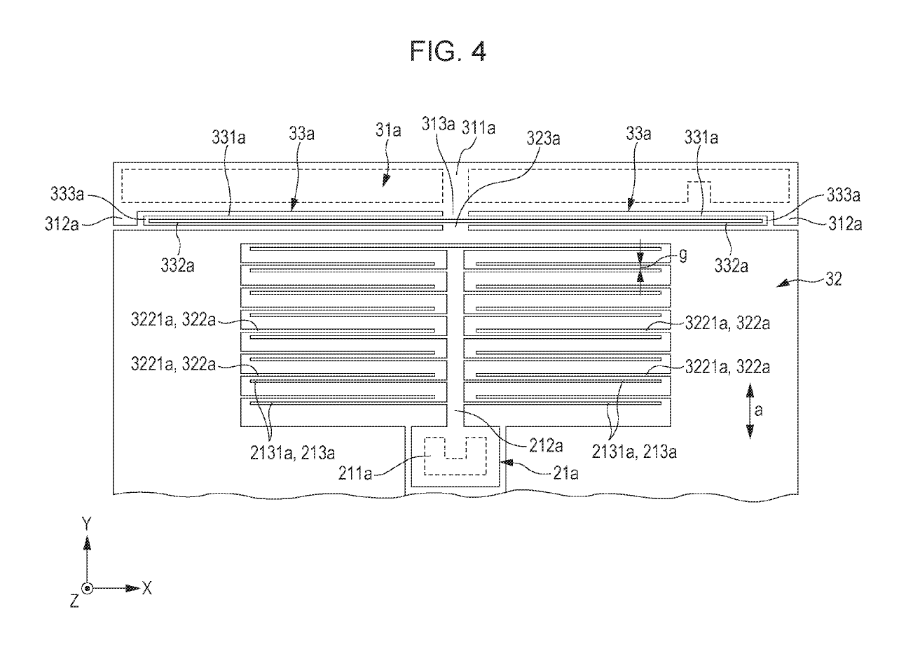

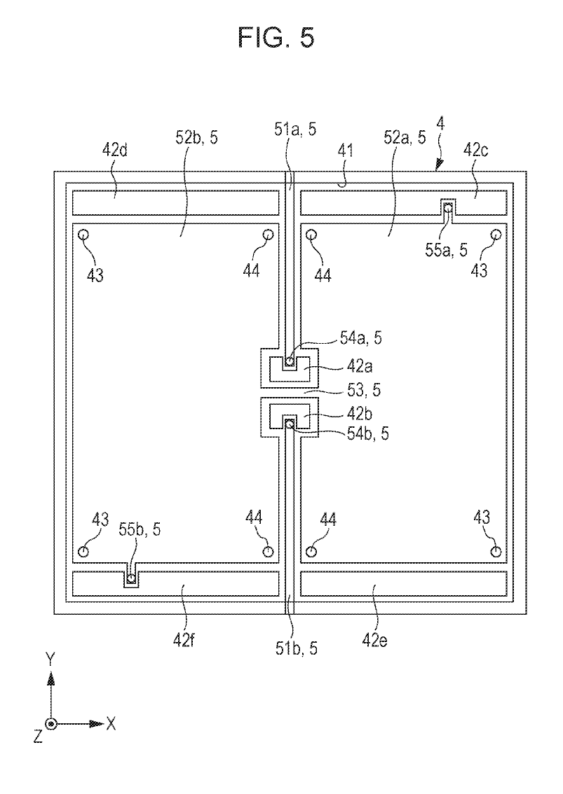

FIG. 1 is a plan view illustrating a physical quantity sensor according to a first embodiment of the invention, FIG. 2 is a sectional view taken along line II-II of the physical quantity sensor illustrated in FIG. 1, and FIG. 3 is a sectional view taken along line III-III of the physical quantity sensor illustrated in FIG. 1. FIG. 4 is an enlarged plan view of a portion for explaining a first fixed electrode portion, a first movable electrode portion, and a first elastic portion included in the physical quantity sensor illustrated in FIG. 1. FIG. 5 is a plan view for explaining a support substrate and a wiring pattern included in a physical quantity sensor illustrated in FIG. 1.

In each of the drawings, for convenience of description, three axes of an X axis, a Y axis, and Z axis which are perpendicular to each other are illustrated by arrows, the tip end side of the arrow is set to “+”, and the base end side of the arrow is set to “−”. In the following, a direction parallel to the X axis (second direction) is referred to as “X axis direction”, a direction parallel to the Y axis (first direction) is referred to as “Y axis direction”, and a direction parallel to the Z axis is referred to as “Z axis direction”. In addition, for convenience of description, in FIGS. 2 and 3, upper side (+Z axis direction side) is referred to as “upper”, and lower side (−Z axis direction side) is referred to as “lower”.

As illustrated in FIGS. 1 to 3, the physical quantity sensor 1 according to the present embodiment includes a sensor element 10, a substrate 4 supporting the sensor element 10, a wiring pattern 5 electrically connected with the sensor element 10 on the substrate 4, and a lid member 6 bonded to the substrate 4 so as to cover the sensor element 10. Here, the substrate 4 and the lid member 6 constitute a package 20 that forms a space S in which the sensor element 10 is accommodated. Hereinafter, each portion of the physical quantity sensor 1 will be sequentially described.

### Sensor Element 10

As illustrated in FIG. 1, the sensor element 10 includes a first fixed electrode side fixing portion 21a and a second fixed electrode side fixing portion 21b that are fixed to the substrate 4, a movable mass portion 32 that surrounds the fixed electrode side fixing portions in a plan view, a first movable electrode side fixing portion 31a and a second movable electrode side fixing portion 31b that are fixed to the substrate 4 and disposed at the outside of the movable mass portion 32 in a plan view, and two first elastic portions 33a that connect the first movable electrode side fixing portion 31a and the movable mass portion 32, and two second elastic portions 33b that connect the second movable electrode side fixing portion 31b and the movable mass portion 32.

Here, the first movable electrode side fixing portion 31a, the second movable electrode side fixing portion 31b, the movable mass portion 32, and two first elastic portions 33a and two second elastic portions 33b are integrally formed, and constitute a movable electrode side structure body 3. In other words, the sensor element 10 includes the first fixed electrode side fixing portion 21a and the second fixed electrode side fixing portion 21b that are disposed with a distance therebetween, and the movable electrode side structure body 3, and the movable electrode side structure body 3 includes the first movable electrode side fixing portion 31a, the second movable electrode side fixing portion 31b, the movable mass portion 32, the first elastic portions 33a, and the second elastic portions 33b that are integrally formed. The sensor element 10 according to the present embodiment has a symmetric shape in a plan view with respect to each direction of the X axis direction and the Y axis direction.

The first fixed electrode side fixing portion 21a and second fixed electrode side fixing portion 21b are disposed side by side along the Y axis direction. Here, the first fixed electrode side fixing portion 21a is disposed to the +Y axis direction side with respect to the center of the sensor element 10, and on the other hand, the second fixed electrode side fixing portion 21b is disposed to the −Y axis direction side with respect to the center of the sensor element 10.

The first fixed electrode side fixing portion 21a includes a connection portion 211a connected to the substrate 4, a first extension portion 212a extended from the connection portion 211a along the +Y axis direction, and a first fixed electrode portion 213a connected to the first extension portion 212a. The first fixed electrode portion 213a is configured with a plurality of first fixed electrode fingers 2131a having one end supported to the first extension portion 212a (refer to FIG. 4). The plurality of the first fixed electrode fingers 2131a are extended from first extension portion 212a along each direction of the +X axis direction and the −X axis direction, and disposed side by side along the Y axis direction with a distance therebetween, thereby constituting a comb-teeth shaped “first fixed electrode comb portion”.

In the same manner, the second fixed electrode side fixing portion 21b includes a connection portion 211b connected to the substrate 4, a second extension portion 212b extended from the connection portion 211b along the −Y axis direction, and a second fixed electrode portion 213b connected to the second extension portion 212b. The second fixed electrode portion 213b is disposed side by side along the −Y axis direction with respect to the first fixed electrode portion 213a, and configured with a plurality of second fixed electrode fingers 2131b having one end supported to the second extension portion 212b. The plurality of the second fixed electrode fingers 2131b are extended from the second extension portion 212b along each direction of the +X axis direction and the −X axis direction, and disposed side by side along the Y axis direction with a distance therebetween, thereby constituting a comb-teeth shaped “second fixed electrode comb portion”.

The first fixed electrode side fixing portion 21a and the second fixed electrode side fixing portion 21b are disposed at the inside of the movable mass portion 32 that has a frame shape in a plan view. In other words, the movable mass portion 32 has a shape surrounding the first fixed electrode side fixing portion 21a and the second fixed electrode side fixing portion 21b in a plan view.

The movable mass portion 32 includes a frame portion 321 that has a frame shape in a plan view, a first movable electrode portion 322a, a second movable electrode portion 322b, and two weight portions 324 that are connected to the frame portion 321.

Here, the first movable electrode portion 322a has a portion that is opposed to the first fixed electrode portion 213a. More specifically, the first movable electrode portion 322a has one end supported to the frame portion 321, and is configured with the plurality of the first movable electrode fingers 3221a that are extended and disposed at the inside of the frame portion 321 so as to engage with the plurality of the first fixed electrode fingers 2131a (the first fixed electrode comb portion) of the first fixed electrode portion 213a with a distance g therebetween (refer FIG. 4). The plurality of the first movable electrode fingers 3221a are extended from the frame portion 321 along the X axis direction, and are disposed side by side along the Y axis direction with a distance therebetween, thereby constituting a comb-teeth shaped “first movable electrode comb portion”.

In the same manner, the second movable electrode portion 322b has a portion that is opposed to the second fixed electrode portion 213b. More specifically, the second movable electrode portion 322b has one end supported to the frame portion 321, and is configured with the plurality of the second movable electrode fingers 3221b that are extended and disposed at the inside of the frame portion 321 so as to engage with the plurality of the second fixed electrode fingers 2131b of the second fixed electrode portion 213b with a distance therebetween. The plurality of the second movable electrode fingers 3221b are extended from the frame portion 321 along the X axis direction, and are disposed side by side along the Y axis direction with a distance therebetween, thereby constituting a comb-teeth shaped “second movable electrode comb portion”.

The weight portion 324 is extended between the first movable electrode fingers 3221a and the second movable electrode fingers 3221b towards the inside of the frame portion 321 from the frame portion 321. The width of the weight portion 324 (the length along the Y axis direction) is wider than that of the first movable electrode fingers 3221a or the second movable electrode fingers 3221b.

When the movable mass portion 32 is seen in a plan view, the first movable electrode side fixing portion 31a and the second movable electrode side fixing portion 31b are disposed at the outside of the movable mass portion 32. The first movable electrode side fixing portion 31a and the second movable electrode side fixing portion 31b are disposed side by side along the Y axis direction intersecting with the X axis direction. In the present embodiment, in a plan view, the first movable electrode side fixing portion 31a is disposed at the +Y axis direction side with respect to the movable mass portion 32 in a plan view, and the second movable electrode side fixing portion 31b is disposed at the −Y axis direction side with respect to the movable mass portion 32.

The first movable electrode side fixing portion 31a includes a connection portion 311a connected to the substrate 4, and two projection portions 312a projected from the connection portion 311a. The connection portion 311a is extended along the X axis direction. The two projection portions 312a that are projected to the −Y axis direction side (the movable mass portion 32 side) are provided at both end portions of the connection portion 311a in the X axis direction. A projection portion (projection portion 313a illustrated in FIG. 4) that is projected to the −Y axis direction side is provided at the center portion of the connection portion 311a in the X axis direction.

In the same manner, the second movable electrode side fixing portion 31b includes a connection portion 311b connected to the substrate 4 and two projection portions 312b that are projected from the connection portion 311b. The connection portion 311b is extended along the X axis direction. The two projection portions 312b that are projected to the +Y axis direction side (the movable mass portion 32 side) are provided at both end portions of the connection portion 311b in the X axis direction. A projection portion that is projected to the +Y axis direction side is provided at the center portion of the connection portion 311b in the X axis direction.

The movable mass portion 32 is supported against the first movable electrode side fixing portion 31a via the two first elastic portions 33a, and supported against the second movable electrode side fixing portion 31b via the two second elastic portions 33b. Therefore, in a plan view, not only the first movable electrode side fixing portion 31a and the second movable electrode side fixing portion 31b, but also the two first elastic portions 33a and the two second elastic portions 33b are disposed at the outside of the movable mass portion 32 having a frame shape.

The two first elastic portions 33a respectively connect the first movable electrode side fixing portion 31a and the movable mass portion 32 so as to allow the movable mass portion 32 to be displaced in the Y axis direction. In the same manner, the two second elastic portions 33b respectively connect the second movable electrode side fixing portion 31b and the movable mass portion 32 so as to allow the movable mass portion 32 to be displaced in the Y axis direction.

More specifically, the two first elastic portions 33a respectively have a shape that is extended to the −Y axis direction while moving meanderingly so as to repeatedly approach and separate to and from the connection portion 311a of the first movable electrode side fixing portion 31a in the X axis direction. In other words, as illustrated in FIG. 4, the first elastic portion 33a includes a portion 331a (a beam) that is extended from the projection portion 313a of the connection portion 311a along the X axis direction, and a portion 332a (a beam) that is extended from the portion 323a which is projected toward the inside of the frame portion 321 along the X axis direction so as to be parallel to the portion 331a, and a portion 333a (link portion) that links the end of the portion 331a and the end of the portion 332a.

In the same manner, the two second elastic portions 33b respectively have a shape that is extended to the +Y axis direction while moving meanderingly so as to repeatedly approach and separate to and from the connection portion 311b of the second movable electrode side fixing portion 31b in the X axis direction.

The shape of the first elastic portion 33a and the second elastic portion 33b are not limited to the above-described shape as long as the shape thereof allows the movable mass portion 32 to be displaced in the Y axis direction. For example, the first elastic portion 33a and the second elastic portion 33b may be configured with a beam extended along the X axis direction, or at least three beams and at least two link portions linking the beams.

Each of the composition materials of the first fixed electrode side fixing portion 21a, the second fixed electrode side fixing portion 21b, and the movable electrode side structure body 3 is not particularly limited. For example, silicon material that has conductivity by doping with impurities such as phosphorus, boron, and the like (single-crystal silicon, polysilicon, or the like), is preferably used.

The first fixed electrode side fixing portion 21a, the second fixed electrode side fixing portion 21b, and the movable electrode side structure body 3 can be collectively formed by etching a substrate (for example, silicon substrate). In this case, it is possible to easily make the thickness of the each portion of the sensor element 10 uniform with high precision. In addition, the silicon substrate can be processed by etching with high precision.

In the sensor element 10 configured as described above, in a case where the sensor element 10 is subjected to acceleration in the Y axis direction serving as a detection axis direction (direction illustrated by the arrow a in FIG. 4), the movable mass portion 32 is displaced in the Y axis direction in accordance with the elastic deformation of the first elastic portion 33a and the second elastic portion 33b. Then, the distance between the first fixed electrode fingers 2131a of the first fixed electrode portion 213a and the first movable electrode fingers 3221a of the first movable electrode portion 322a, and the distance between the second fixed electrode fingers 2131b of the second fixed electrode portion 213b and the second movable electrode fingers 3221b of the second movable electrode portion 322b are respectively changed.

Therefore, it is possible to detect the quantity of the acceleration to which the sensor element 10 is subjected based on capacitance between the first fixed electrode fingers 2131a and the first movable electrode fingers 3221a and capacitance between the second fixed electrode fingers 2131b and the second movable electrode fingers 3221b. In the present embodiment, when one of the distance between the first fixed electrode fingers 2131a and the first movable electrode fingers 3221a, and the distance between the second fixed electrode fingers 2131b and the second movable electrode fingers 3221b increases, the other of the distances decreases. For this reason, when one of the capacitance between the first fixed electrode fingers 2131a and the first movable electrode fingers 3221a, and the capacitance between the second fixed electrode fingers 2131b and the second movable electrode fingers 3221b increases, the other of the capacitances also decreases. Therefore, a signal based on the capacitance between the first fixed electrode fingers 2131a of the first fixed electrode portion 213a and the first movable electrode fingers 3221a of the first movable electrode portion 322a, and a signal based on the capacitance between the second fixed electrode fingers 2131b of the second fixed electrode portion 213b and the second movable electrode fingers 3221b of the second movable electrode portion 322b are differentially operated. Accordingly, it is possible to output a signal corresponding to the acceleration to which the sensor element 10 is subjected while reducing noise by removing signal components caused by the displacement of the movable mass portion 32 other than the detection axis direction.

### Substrate

The substrate 4 (support substrate) has a plate shape, is disposed along XY plane (reference face) that is a plane including the X axis and the Y axis. As illustrated in FIGS. 2 and 3, a recess portion 41 is provided on the upper face (face on the side where the sensor element 10 is provided) of the substrate 4. The recess portion 41 has a function of preventing the movable portions (the movable mass portion 32, the first elastic portion 33a, and the second elastic portion 33b) of the sensor element 10 from coming into contact with the substrate 4. Accordingly, the substrate 4 can support the sensor element 10 while allowing the sensor element 10 to drive.

As illustrated in FIG. 5, a first protrusion portion 42a, a second protrusion portion 42b, two third protrusion portions 42c and 42d, two fourth protrusion portions 42e and 42f, four protrusion portions 43, and four protrusion portions 44 that protruded from the bottom face of the recess portion 41 are provided on the upper face of the substrate 4.

The first protrusion portion 42a, the second protrusion portion 42b, the two third protrusion portions 42c and 42d, and the two fourth protrusion portions 42e and 42f have a function of supporting the sensor element 10 in a state where the movable portions of the sensor element 10 is floated with respect to the substrate 4.

More specifically, the first protrusion portion 42a and the second protrusion portion 42b are disposed side by side along the Y axis direction in the vicinity of the center of the sensor element 10. Here, the first protrusion portion 42a is disposed at the +Y axis direction side with respect to the center of the sensor element 10, and on the other hand, the second protrusion portion 42b is disposed to the −Y axis direction side with respect to the center of the sensor element 10.

The connection portion 211a of the first fixed electrode side fixing portion 21a is bonded to the first protrusion portion 42a. On the other hand, the connection portion 211b of the second fixed electrode side fixing portion 21b is bonded to the second protrusion portion 42b.

The two third protrusion portions 42c and 42d, and the two fourth protrusion portions 42e and 42f are divided in the vicinity of the both end portions of the sensor element 10 in the Y axis direction, and disposed side by side along the Y axis direction. Here, the two third protrusion portions 42c and 42d are disposed at the end portion of the sensor element 10 in the +Y axis direction side, and on the other hand, the two fourth protrusion portions 42e and 42f are disposed at the end portion of the sensor element 10 in the −Y axis direction side. In addition, the third protrusion portion 42c and the fourth protrusion portion 42e are disposed at the +X axis direction side with respect to the center of the sensor element 10, and on the other hand, the third protrusion portion 42d and the fourth protrusion portion 42f are disposed at the −X axis direction side with respect to the center of the sensor element 10.

The connection portion 311a of the first movable electrode side fixing portion 31a is bonded to the two third protrusion portions 42c and 42d. On the other hand, the connection portion 311b of the second movable electrode side fixing portion 31b is bonded to the two fourth protrusion portions 42e and 42f.

The four protrusion portions 43 and the four protrusion portions 44 have a function of preventing the suspension portion of the sensor element 10 (in particular, the movable mass portion 32) from adhering to the substrate 4.

More specifically, in a plan view, the four protrusion portions 43 are disposed at a position that overlaps with the outer peripheral portion of the movable mass portion 32 (more specifically, four corners of the frame portion 321 having a quadrangular outer shape in a plan view). Accordingly, it is possible to effectively prevent the movable mass portion 32 from adhering to the substrate 4.

In a plan view, the four protrusion portions 44 are disposed at a portion that is in vicinity of a portion at which the upper face of the substrate 4 is exposed from the wiring pattern 5 which will be described later (portion which a large amount of electric field is applied to during anode bonding) and that overlaps with the movable mass portion 32. Accordingly, it is possible to effectively prevent the movable mass portion 32 from adhering to the substrate 4.

The composition materials of the substrate 4 are not particularly limited, but substrate materials having insulation properties are preferably used. More specifically, a quartz substrate, a sapphire substrate, or a glass substrate is preferably used, in particular, a glass material containing alkali metal ions (movable ions) (for example, borosilicate glass such as Pyrex glass (registered trademark)) is preferably used. Accordingly, in a case where the sensor element 10 or the lid member 6 is formed of silicon as a main material, it is possible to bond the sensor element 10 or the lid member 6 to the substrate 4 using anode bonding.

In FIG. 5, the substrate 4 is configured with one member, but the substrate 4 may be configured by bonding two or more members. For example, the substrate 4 may be configured by bonding a frame-shaped member and a plate-shaped member.

The substrate 4 can be formed by using a photolithography method, an etching method, or the like, for example.

### Wiring Pattern

The wiring pattern 5 is provided on the upper face of the substrate 4. The wiring pattern 5 includes a first fixed electrode side wiring 51a electrically connected to the first fixed electrode side fixing portion 21a, a second fixed electrode side wiring 51b electrically connected to the second fixed electrode side fixing portion 21b, and movable electrode side wirings 52a, 52b, and 53 electrically connected to the first movable electrode side fixing portion 31a and the second movable electrode side fixing portion 31b.

The first fixed electrode side wiring 51a is extended from the vicinity of the first protrusion portion 42a and disposed to the +Y axis direction side. The end portion of the first fixed electrode side wiring 51a in the −Y axis direction side is connected to the first fixed electrode side fixing portion 21a via a first contact portion 54a. The end portion of the first fixed electrode side wiring 51a in the +Y axis direction side is drawn to the outside of the package 20 and electrically connected to an external terminal (not illustrated). In the same manner, the second fixed electrode side wiring 51b is extended from the vicinity of the second protrusion portion 42b and disposed to the −Y axis direction side. The end portion of the second fixed electrode side wiring 51b in the +Y axis direction side is connected to the second fixed electrode side fixing portion 21b via a second contact portion 54b. The end portion of the second fixed electrode side wiring 51b in the −Y axis direction side is drawn to the outside of the package 20 and electrically connected to an external terminal (not illustrated). Here, it is said that the portion connected with the first contact portion 54a in the first fixed electrode side fixing portion 21a constitutes a portion of the connection portion 211a connected with the substrate 4 in the first fixed electrode side fixing portion 21a. In the same manner, it is said that the portion connected with the second contact portion 54b in the second fixed electrode side fixing portion 21b constitutes a portion of the connection portion 211b connected with the substrate 4 in the second fixed electrode side fixing portion 21b.

The movable electrode side wiring 52a is disposed to the +X axis direction side with respect to the center of the sensor element 10 so as to maximally overlap with the portion of the sensor element 10 in the +X axis direction side (particularly, the movable mass portion 32) in a plan view. In the same manner, the movable electrode side wiring 52b is disposed to the −X axis direction side with respect to the center of the sensor element 10 so as to maximally overlap with the portion of the sensor element 10 in the −X axis direction side (particularly, the movable mass portion 32) in a plan view. The movable electrode side wiring 52a or the movable electrode side wiring 52b is drawn to the outside of the package 20 and electrically connected to an external terminal (not illustrated).

The movable electrode side wiring 53 includes a portion disposed between the first protrusion portion 42a and the second protrusion portion 42b, and connects the movable electrode side wiring 52a and the movable electrode side wiring 52b. The movable electrode side wiring 52a is connected to the first movable electrode side fixing portion 31a via a third contact portion 55a. In the same manner, the movable electrode side wiring 52b is connected to the second movable electrode side fixing portion 31b via a fourth contact portion 55b. Here, it is said that a portion connected with the third contact portion 55a in the first movable electrode side fixing portion 31a constitutes a portion of the connection portion 311a connected with the substrate 4 in the first movable electrode side fixing portion 31a. In the same manner, it is said that a portion connected with the fourth contact portion 55b in the second movable electrode side fixing portion 31b constitutes a portion of the connection portion 311b connected with the substrate 4 in the second movable electrode side fixing portion 31b.

The composition materials of the wiring pattern 5 are not particularly limited as long as each of the materials has conductivity, and various electrode materials can be used. For example, transparent electrode materials such as indium tin oxide (ITO), zinc oxide (ZnO), or the like, metal materials such as gold (Au), gold alloy, platinum (Pt), aluminum (Al), aluminum alloy, silver (Ag), silver alloy, chromium (Cr), chromium alloy, copper (Cu), molybdenum (Mo), niobium (Nb), tungsten (W), iron (Fe), titanium (Ti), cobalt (Co), zinc (Zn), zirconium (Zr), or the like, and semiconductor materials such as silicon (Si) or the like can be used.

The wiring pattern 5 is collectively formed, by forming a film with the materials using a vapor phase film deposition method such as a sputtering method and a vapor deposition method or the like, and patterning the film using a photolithography method, an etching method, or the like. In a case where the substrate 4 is made of semiconductor material such as silicon or the like, it is preferable that an insulating layer is provided between the substrate 4 and the wiring pattern 5. As composition materials of the insulating layer, for example, silicon oxide (SiO₂), aluminum nitride (AlN), silicon nitride (SiN), or the like can be used.

The composition materials of each of the contact portions are not particularly limited as long as each of the materials has conductivity, and various electrode materials can be used, similarly to the wiring pattern 5. For example, a single metal such as Au, Pt, Ag, Cu, Al, or the like, a metal such as metal alloy or the like containing those is preferably used. By forming each of the contact portions using the materials, it is possible to reduce the contact resistance between the wiring pattern 5 and the sensor element 10.

### Lid Member

The lid member 6 illustrated in FIGS. 2 and 3 has a function of protecting the sensor element 10.

The lid member 6 is bonded to the substrate 4, and a space S for accommodating the sensor element 10 is formed between the lid member 6 and the substrate 4.

More specifically, the lid member 6 has a plate shape, and a recess portion 61 is provided at the lower face of the lid member 6 (face on the sensor element 10 side). The recess portion 61 is formed to allow the movable portions of the sensor element 10 to be displaced.

The outside portion rather than the recess portion 61 on the bottom face of the lid member 6 is bonded to the upper face of the substrate 4. The method of bonding the lid member 6 and the substrate 4 is not particularly limited, and for example, a bonding method using bonding agent, an anode bonding method, a direct bonding method, or the like can be used.

The composition materials of the lid member 6 are not particularly limited as long as each of the materials can exhibit the above-described function, and for example, a silicon material, a glass material, or the like can be preferably used.

According to the physical quantity sensor 1 described above, in a plan view, the movable mass portion 32 has a frame shape, and the two fixed electrode side fixing portions (the first fixed electrode side fixing portion 21a and the second fixed electrode side fixing portion 21b) are disposed at the inside of the movable mass portion 32. Thus, it is possible to shorten the distance between the first fixed electrode side fixing portion 21a and the second fixed electrode side fixing portion 21b (more specifically, the distance between the connection portion 211a and the connection portion 211b). Therefore, even when the substrate 4 is warped in accordance with a change in temperature, the sensor element 10 is less affected by warpage of the substrate 4. As a result, the sensor element 10 has excellent temperature characteristics.

Here, the warpage of the substrate 4 due to a change in temperature is caused by, for example, a difference in linear expansion coefficient between the substrate 4 and the sensor element 10 or between the substrate 4 and the lid member 6. Although not illustrated, the warpage of the substrate 4 may be caused by stress generated when bonding a support substrate (package substrate, interposer substrate, or the like), or forming a thin film or the like on the face of the substrate 4 opposite to the sensor element 10. Therefore, in a case where the warpage of the substrate 4 occurs, it is possible to remarkably produce an effect of improving the temperature characteristics.

The two movable electrode side fixing portions (the first movable electrode side fixing portion 31a and the second movable electrode side fixing portion 31b), and the first elastic portion 33a and the second elastic portion 33b are disposed at the outside of the movable mass portion 32 in a plan view, and thus it is possible to increase the degree of freedom of the arrangement of the first movable electrode side fixing portion 31a and the second movable electrode side fixing portion 31b (more specifically, the connection portion 311a and 311b). As a result, it is possible to stably support the movable mass portion 32. Particularly, a portion of one end side of the movable mass portion 32 in the Y axis direction (detection axis direction) is supported by the first elastic portion 33a, a portion of the other end side thereof is supported by the second elastic portion 33b, and thus unnecessary vibration mode of the movable mass portion 32 (for example, vibration mode of a rotating system) is reduced. As a result, it is possible to improve accuracy of the detection characteristics.

In the physical quantity sensor 1, each of the first movable electrode fingers 3221a, each of the second movable electrode fingers 3221b, each of the first fixed electrode fingers 2131a, and each of the second fixed electrode fingers 2131b is extended along the X axis direction perpendicular to the detection axis direction. Thus, it is possible to respectively increase a change in capacitance between the first fixed electrode portion 213a and the first movable electrode portion 322a, and a change in capacitance between the second fixed electrode portion 213b and the second movable electrode portion 322b, in accordance with the displacement of the movable mass portion 32. Therefore, it is possible to improve the sensitivity of the physical quantity sensor 1.

Further, each of the first extension portion 212a and the second extension portion 212b is extended along the Y axis direction serving as the detection axis direction. Thus, it is possible to efficiently increase the number of each of the first movable electrode fingers 3221a, the second movable electrode fingers 3221b, the first fixed electrode fingers 2131a, and the second fixed electrode fingers 2131b. Therefore, it is possible to further increase a change in capacitance between the first fixed electrode portion 213a and the first movable electrode portion 322a, and a change in capacitance between the second fixed electrode portion 213b and the second movable electrode portion 322b, in accordance with the displacement of the movable mass portion 32.

In the present embodiment, as described above, the first fixed electrode side fixing portion 21a and the second fixed electrode side fixing portion 21b are disposed side by side along the Y axis direction serving as the detection axis direction. The first extension portion 212a is extended toward the side opposite to the second fixed electrode side fixing portion 21b, on the other hand, the second extension portion 212b is extended toward the side opposite to the first fixed electrode side fixing portion 21a.

By disposing the first extension portion 212a and the second extension portion 212b in this manner, it is possible to configure the first fixed electrode portion 213a and the second fixed electrode portion 213b in a symmetrical shape with respect to the Y axis direction, and reduce a difference between amplitude of noise component of the signal due to the change in capacitance between the first fixed electrode portion 213a and the first movable electrode portion 322a, and amplitude of noise component of the signal due to the change in capacitance between the second fixed electrode portion 213b and the second movable electrode portion 322b. Therefore, it is possible to efficiently reduce noise by a differential operation of the signal due to the change in capacitance between the first fixed electrode portion 213a and the first movable electrode portion 322a, and the signal due to the change in capacitance between the second fixed electrode portion 213b and the second movable electrode portion 322b. The first fixed electrode side fixing portion 21a and the second fixed electrode side fixing portion 21b are disposed side by side along the Y axis direction, and thus, when the substrate 4 to which the first fixed electrode side fixing portion 21a, the second fixed electrode side fixing portion 21b, the first movable electrode side fixing portion 31a, and the second movable electrode side fixing portion 31b are fixed is warped in the X axis direction, the first fixed electrode portion 213a and the second fixed electrode portion 213b can be effectively less affected by the warpage of the substrate 4.

The movable mass portion 32 has two weight portions 324 formed by effectively using a gap between the first movable electrode fingers 3221a and the second movable electrode fingers 3221b. Therefore, it is possible to increase the mass of the movable mass portion 32 and increase the area of the movable mass portion 32 toward the center of the physical quantity sensor 1. As a result, it is possible to reduce the displacement of the movable mass portion 32, for example, due to external vibration (for example, in-plane rotation), and improve the sensitivity of the physical quantity sensor.

Further, the two projection portions 312a provided in the first movable electrode side fixing portion 31a, and the two projection portions 312b provided in the second movable electrode side fixing portion 31b function as a “stopper” regulating the amount of displacement of the movable mass portion 32 in the Y axis direction and around the Z axis. Accordingly, unintentional displacement of the movable mass portion 32 in in-plane direction can be reduced (or excessive displacement of the movable mass portion 32 can be prevented), and as a result, it is possible to improve impact resistance.

In a plan view, the first extension portion 212a includes a portion that overlaps with the first fixed electrode side wiring 51a electrically connected to the first fixed electrode fingers 2131a. In the same manner, in a plan view, the second extension portion 212b includes a portion that overlaps with the second fixed electrode side wiring 51b electrically connected to the second fixed electrode fingers 2131b. Here, the first extension portion 212a and the first fixed electrode side wiring 51a have the same potential with each other, and the second extension portion 212b and the second fixed electrode side wiring 51b have the same potential with each other. Therefore, by overlapping the first extension portion 212a with the first fixed electrode side wiring 51a in a plan view, and overlapping the second extension portion 212b with the second fixed electrode side wiring 51b in a plan view, it is possible to reduce parasitic capacitance generated between the substrate 4 and the first extension portion 212a, and between the substrate 4 and the second extension portion 212b. As a result, the physical quantity sensor 1 can have excellent detection characteristics.

In addition, in a plan view, the tip of the first movable electrode fingers 3221a overlaps with the movable electrode side wiring 52a electrically connected to the first movable electrode fingers 3221a, and the tip of the second movable electrode fingers 3221b overlaps with the movable electrode side wiring 52b electrically connected to the second movable electrode fingers 3221b. Accordingly, for example, when the sensor element 10 serving as a structure body including the first fixed electrode side fixing portion 21a and the second fixed electrode side fixing portion 21b is bonded to the substrate 4 by using anode bonding, the tip of the first movable electrode fingers 3221a is opposed to the movable electrode side wiring 52a having the same potential as that of the tip of the first movable electrode fingers, and the tip of the second movable electrode fingers 3221b is opposed to the movable electrode side wiring 52b having the same potential as that of the tip of the second movable electrode fingers. Therefore, during performing the anode bonding, electric field generated between the tip of the first movable electrode fingers 3221a and the substrate 4, and between the tip of the second movable electrode fingers 3221b and the substrate 4 is reduced. As a result, it is possible to prevent or reduce adherence of each of the first movable electrode fingers 3221a and each of the second movable electrode fingers 3221b to the substrate 4.

As described above, both of the connection portion 311a of the first movable electrode side fixing portion 31a and the connection portion 311b of the second movable electrode side fixing portion 31b are connected to the movable electrode side wiring 52a or the movable electrode side wiring 52b. Accordingly, the first movable electrode side fixing portion 31a and the second movable electrode side fixing portion 31b have the same potential with each other. Thus, electrical contact between the movable electrode side structure body 3 serving as a structure body including the first movable electrode side fixing portion 31a and the second movable electrode side fixing portion 31b, and the movable electrode side wirings 52a and 52b, can be made, at a plurality of positions by using the third contact portion 55a and the fourth contact portion 55b. Therefore, it is possible to improve reliability of the contact.

As described above, the third contact portion 55a with conductivity is provided between the connection portion 311a and the movable electrode side wiring 52a, being in contact with the connection portion 311a and the movable electrode side wiring 52a, and the fourth contact portion 55b with conductivity is provided between the connection portion 311b and the movable electrode side wiring 52b, being in contact with the connection portion 311b and the movable electrode side wiring 52b. Accordingly, it is possible to improve reliability of the electrical contact between the movable electrode side structure body 3 and the movable electrode side wirings 52a and 52b.

As described above, a plurality of protrusion portions 43 and a plurality of protrusion portions 44 are provided on the main face of the substrate 4, being overlap with the movable mass portion 32, in a plan view. Accordingly, it is possible to regulate the movement of the movable mass portion 32 in an out-of-plane direction by the protrusion portions 43 and 44. As a result, it is possible to prevent or reduce adherence of the movable mass portion 32 to the substrate 4.

The length of a portion that each of the first movable electrode side fixing portion 31a and the second movable electrode side fixing portion 31b is fixed to the substrate 4 (portion that is connected to the third protrusion portions 42c and 42d, and the fourth protrusion portions 42e and 42f) in the Y axis direction, is shorter than the length of the movable mass portion 32 in the Y axis direction. Accordingly, it is possible to reduce a bonding area between the first movable electrode side fixing portion 31a and the substrate 4, and between the second movable electrode side fixing portion 31b and the substrate 4, for fixing the first movable electrode side fixing portion 31a and the second movable electrode side fixing portion 31b to the substrate 4. Therefore, it is possible to reduce stress that is transmitted from the substrate 4 to the movable electrode side structure body 3 serving as the structure body including the first movable electrode side fixing portion 31a and the second movable electrode side fixing portion 31b.

### Second Embodiment

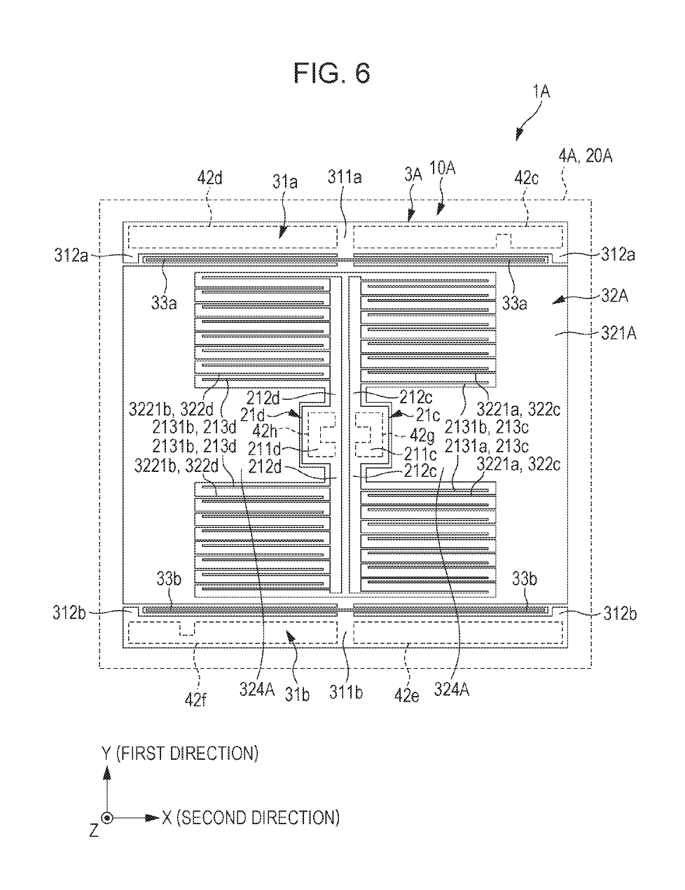

FIG. 6 is a plan view illustrating a physical quantity sensor according to a second embodiment of the invention.

The physical quantity sensor according to the present embodiment is mainly similar to the physical quantity sensor according to the first embodiment, except that configurations of the first fixed electrode side fixing portion and the second fixed electrode side fixing portion are different.

In the following description, the second embodiment will be described, focusing on a difference from the first embodiment, description relating to the matters similar to the first embodiment is not repeated. In FIG. 6, the same reference numerals are given to the member having a same configuration as that of the member described in the first embodiment.

As illustrated in FIG. 6, the physical quantity sensor 1A according to the present embodiment includes a sensor element 10A, and a substrate 4A supporting the sensor element 10A. Here, the substrate 4A and a lid member (not illustrated) constitute a package 20A that a space accommodating the sensor element 10A is formed.

The sensor element 10A includes a first fixed electrode side fixing portion 21c supported to a protrusion portion 42g of the substrate 4A, a second fixed electrode side fixing portion 21d supported to a protrusion portion 42h of the substrate 4A, and a movable electrode side structure body 3A. The sensor element 10A according to the present embodiment has a rotationally symmetric shape in a plan view.

The first fixed electrode side fixing portion 21c and the second fixed electrode side fixing portion 21d are disposed side by side along the X axis direction. Here, the first fixed electrode side fixing portion 21c is disposed to the +X axis direction side with respect to the center of the sensor element 10A, on the other hand, the second fixed electrode side fixing portion 21d is disposed to the −X axis direction side with respect to the center of the sensor element 10A.

The first fixed electrode side fixing portion 21c includes a connection portion 211c connected to the substrate 4A, a first extension portion 212c extended from the connection portion 211c along each direction of the +Y axis direction and the −Y axis direction, and a first fixed electrode portion 213c connected to the first extension portion 212c. The first fixed electrode portion 213c is configured with a plurality of first fixed electrode fingers 2131a that have one ends supported to the first extension portion 212c and are extended along the +X axis direction.

In the same manner, the second fixed electrode side fixing portion 21d includes a connection portion 211d connected to the substrate 4A, a second extension portion 212d extended from the connection portion 211d along each direction of the +Y axis direction and the −Y axis direction, and a second fixed electrode portion 213d connected to the second extension portion 212d. The second fixed electrode portion 213d is disposed side by side along the −X axis direction with respect to the first fixed electrode portion 213c, and configured with a plurality of second fixed electrode fingers 2131b that have one ends supported to the second extension portion 212d and are extended along the −X axis direction.

In the present embodiment, the plurality of the first fixed electrode fingers 2131a included in the first fixed electrode side fixing portion 21c are divided into an electrode finger group that is configured with the plurality of the first fixed electrode fingers 2131a disposed to the +Y axis direction side, and an electrode finger group that is configured with the plurality of first fixed electrode fingers 2131a disposed to the −Y axis direction side. In the same manner, the plurality of the second fixed electrode fingers 2131b included in the second fixed electrode side fixing portion 21d are divided into an electrode finger group that is configured with the plurality of the second fixed electrode fingers 2131b disposed to the +Y axis direction side, and an electrode finger group that is configured with the plurality of second fixed electrode fingers 2131b disposed to the −Y axis direction side.

The movable electrode side structure body 3A includes a movable mass portion 32A. In a plan view, the movable mass portion 32A has a shape surrounding the first fixed electrode side fixing portion 21c and the second fixed electrode side fixing portion 21d. The movable mass portion 32A includes a frame portion 321A having a frame shape in a plan view, a first movable electrode portion 322c and a second movable electrode portion 322d connected to the frame portion 321A, and two weight portions 324A.

Here, the first movable electrode portion 322c includes a plurality of first movable electrode fingers 3221a that are extended from the frame portion 321A along the −X axis direction and disposed side by side along the Y axis direction with a distance therebetween, so as to engage with the plurality of the first fixed electrode fingers 2131a of the first fixed electrode portion 213c (first fixed electrode comb portion) with a distance therebetween. In the same manner, the second movable electrode portion 322d includes a plurality of second movable electrode fingers 3221b that are extended from the frame portion 321A along the +X axis direction and disposed side by side along the Y axis direction with a distance therebetween, so as to engage with the plurality of the second fixed electrode fingers 2131b of the second fixed electrode portion 213d (second fixed electrode comb portion) with a distance therebetween.

In the present embodiment, the plurality of the first movable electrode fingers 3221a included in the first movable electrode side fixing portion 31a are divided into an electrode finger group that is configured with a plurality of the first movable electrode fingers 3221a disposed to the +Y axis direction side, and an electrode finger group that is configured with a plurality of first movable electrode fingers 3221a disposed to the −Y axis direction side. In the same manner, the plurality of the second movable electrode fingers 3221b included in the second movable electrode side fixing portion 31b are divided into an electrode finger group that is configured with the plurality of the second movable electrode fingers 3221b disposed to the +Y axis direction side, and an electrode finger group that is configured with the plurality of the second movable electrode fingers 3221b disposed to the −Y axis direction side.

The two weight portions 324A respectively enter between two electrode finger groups of the first movable electrode portion 322c (more specifically, between two electrode finger groups of the first fixed electrode portion 213c), and between two electrode finger groups of the second movable electrode portion 322d (more specifically, between two electrode finger groups of the second fixed electrode portion 213d), and are extended from the frame portion 321A.

In the physical quantity sensor 1A with a configuration described above, the first extension portion 212c includes a portion extended to one side in the Y axis direction, and the second extension portion 212d includes a portion extended to the other side in the Y axis direction. Thus, it is possible to configure the first fixed electrode portion 213c and the second fixed electrode portion 213d in a rotationally symmetric shape, and reduce a difference in amplitude of noise component of the signal due to the change in capacitance between the first fixed electrode portion 213c and the first movable electrode portion 322c, and amplitude of noise component of the signal due to the change in capacitance between the second fixed electrode portion 213d and the second movable electrode portion 322d. Therefore, it is possible to efficiently reduce noise by a differential operation of the signal due to the change in capacitance between the first fixed electrode portion 213c and the first movable electrode portion 322c, and the signal due to the change in capacitance between the second fixed electrode portion 213d and the second movable electrode portion 322d. The first fixed electrode side fixing portion 21c and the second fixed electrode side fixing portion 21d are disposed side by side along the X axis direction, and thus, when the substrate 4A is warped in the Y axis direction, the fixed electrode portions and the movable electrode portions can be effectively less affected by the warpage of the substrate 4A.

Particularly, in the present embodiment, each of the first extension portion 212c and the second extension portion 212d has two portions extended to one side and the other side in the Y axis direction, and thus it is possible to improve impact resistance against vibration in the X axis direction. In addition, it is possible to efficiently increase the number of the first fixed electrode fingers 2131a the second fixed electrode fingers 2131b while configuring the physical quantity sensor 1A with an excellent symmetric shape.

The movable mass portion 32A includes two weight portions 324A formed by efficiently using between the two first movable electrode fingers 3221a of the first movable electrode portion 322c, and between the two second movable electrode fingers 3221b of the second movable electrode portion 322d. Therefore, it is possible to increase the mass of the movable mass portion 32A and increase the area of the movable mass portion 32A toward the center of the physical quantity sensor 1A. As a result, it is possible to reduce the displacement of the movable mass portion 32A, for example, due to external vibration (for example, in-plane rotation), and improve sensitivity of the physical quantity sensor 1A.

The physical quantity sensor 1A according to the second embodiment described above also can realize excellent properties.

### Third Embodiment

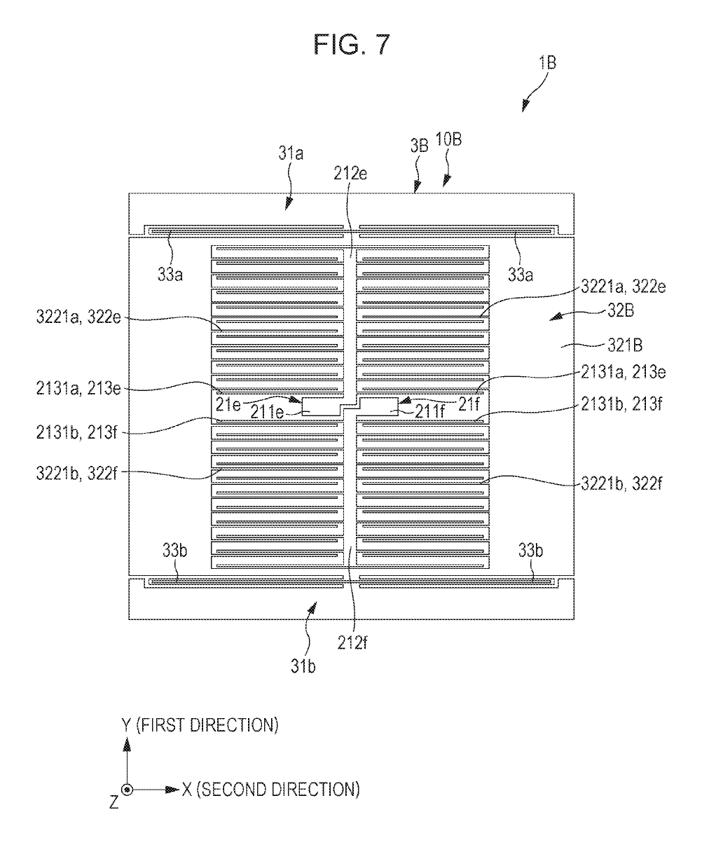

FIG. 7 is a plan view illustrating a physical quantity sensor according to a third embodiment of the invention.

The physical quantity sensor according to the present embodiment is similar to the physical quantity sensor according to the first embodiment, except that the weight portions are omitted and the number of the electrode fingers increased.

In the following description, the third embodiment will be described, focusing on a difference from the embodiment described above, description relating to the matters similar to the embodiment is not repeated. In FIG. 7, the same reference numerals are given to the member having a same configuration as that of the member described in the first embodiment.

As illustrated in FIG. 7, the physical quantity sensor 1B according to the present embodiment includes a sensor element 10B. The sensor element 10B includes a first fixed electrode side fixing portion 21e, a second fixed electrode side fixing portion 21f, and a movable electrode side structure body 3B.

The first fixed electrode side fixing portion 21e and the second fixed electrode side fixing portion 21f are disposed side by side along the Y axis direction.

The first fixed electrode side fixing portion 21e includes a connection portion 211e connected to the substrate (not illustrated), a first extension portion 212e extended from the connection portion 211e along the +Y axis direction, and first fixed electrode portions 213e connected to the first extension portion 212e. The first fixed electrode portion 213e is configured with the plurality of the first fixed electrode fingers 2131a that have one ends supported to the first extension portion 212e and are extended along each direction of the +X axis direction and the −X axis direction.

In the same manner, the second fixed electrode side fixing portion 21f includes a connection portion 211f connected to the substrate (not illustrated), a second extension portion 212f extended from the connection portion 211f along the −Y axis direction, and second fixed electrode portions 213f connected to the second extension portion 212f. The connection portion 211f is disposed side by side along the +X axis direction with respect to the connection portion 211e. The second fixed electrode portion 213f is disposed side by side along the −Y axis direction with respect to the first fixed electrode portion 213e, and configured with the plurality of the second fixed electrode fingers 2131b that have one ends supported to the second extension portion 212f and are extended along each direction of the +X axis direction and the −X axis direction.

In the present embodiment, the distance between the first fixed electrode portion 213e and the second fixed electrode portion 213f is shorter than the distance between the first fixed electrode portion 213a and the second fixed electrode portion 213b according to the first embodiment.

The movable electrode side structure body 3B includes a movable mass portion 32B. The movable mass portion 32B has a shape surrounding the first fixed electrode side fixing portion 21e and the second fixed electrode side fixing portion 21f in a plan view. The movable mass portion 32B includes a frame portion 321B having a frame shape in a plan view, and a first movable electrode portion 322e and a second movable electrode portion 322f connected to the frame portion 321B.

The physical quantity sensor 1B according to the third embodiment described above also can realize excellent properties.

### Fourth Embodiment

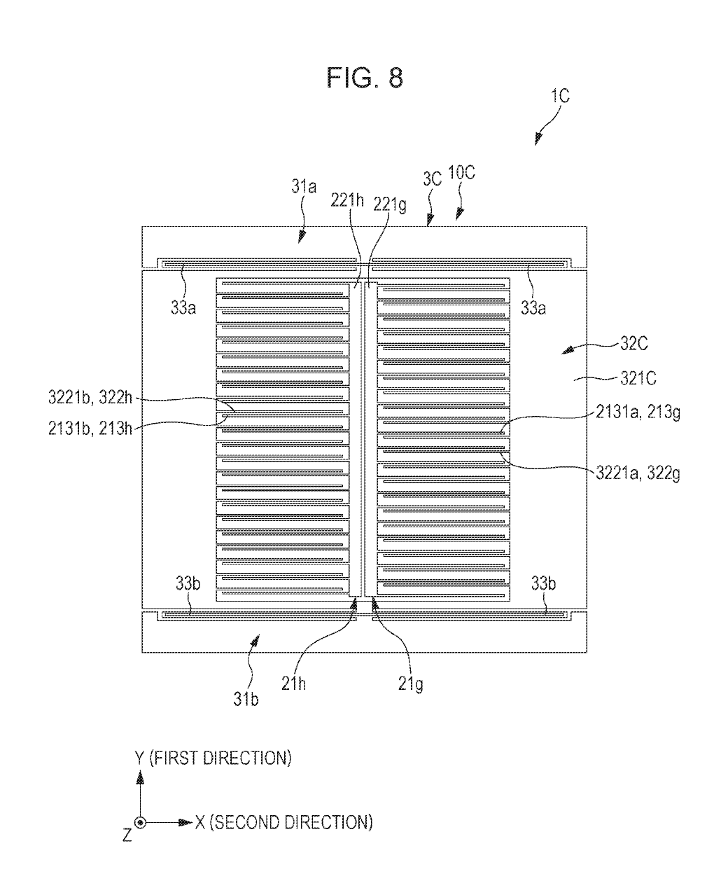

FIG. 8 is a plan view illustrating a physical quantity sensor according to a fourth embodiment of the invention.

The physical quantity sensor according to the present embodiment is similar to the physical quantity sensor according to the second embodiment, except that the weight portions are omitted and the number of the electrode fingers increased.

In the following description, the fourth embodiment will be described, focusing on a difference from the embodiment described above, description relating to the matters similar to the embodiment is not repeated. In FIG. 8, the same reference numerals are given to the member having a same configuration as that of the member described in the first embodiment.

As illustrated in FIG. 8, the physical quantity sensor 1C according to the present embodiment includes a sensor element 10C. The sensor element 10C includes a first fixed electrode side fixing portion 21g, a second fixed electrode side fixing portion 21h, and a movable electrode side structure body 3C.

The first fixed electrode side fixing portion 21g and the second fixed electrode side fixing portion 21h are disposed side by side along the X axis direction.

The first fixed electrode side fixing portion 21g includes a first extension portion 221g that has a portion (connection portion) connected to the substrate (not illustrated) and is extended along the Y axis direction, and a first fixed electrode portion 213g connected to the first extension portion 221g. The first fixed electrode portion 213g is configured with the plurality of the first fixed electrode fingers 2131a that have one ends supported to the first extension portion 221g and are extended along the +X axis direction.

In the same manner, the second fixed electrode side fixing portion 21h includes a second extension portion 221h that has a portion (connection portion) connected to the substrate (not illustrated) and is extended along the Y axis direction, and a second fixed electrode portion 213h connected to the second extension portion 221h. The second fixed electrode portion 213h is disposed side by side along the −X axis direction with respect to the first fixed electrode portion 213g, and configured with the plurality of the second fixed electrode fingers 2131b that have one ends supported to the second extension portion 212h and are extended along the −X axis direction.

In the present embodiment, the plurality of the first fixed electrode fingers 2131a and the plurality of the second fixed electrode fingers 2131b are respectively arranged at equal intervals in the Y axis direction.

The movable electrode side structure body 3C includes a movable mass portion 32C. The movable mass portion 32C has a shape surrounding the first fixed electrode side fixing portion 21g and the second fixed electrode side fixing portion 21h in a plan view. The movable mass portion 32C includes a frame portion 321C having a frame shape in a plan view, and a first movable electrode portion 322g and a second movable electrode portion 322h connected to the frame portion 321C.

The physical quantity sensor 1C according to the fourth embodiment described above also can realize excellent properties.

### 2. Electronic Apparatus

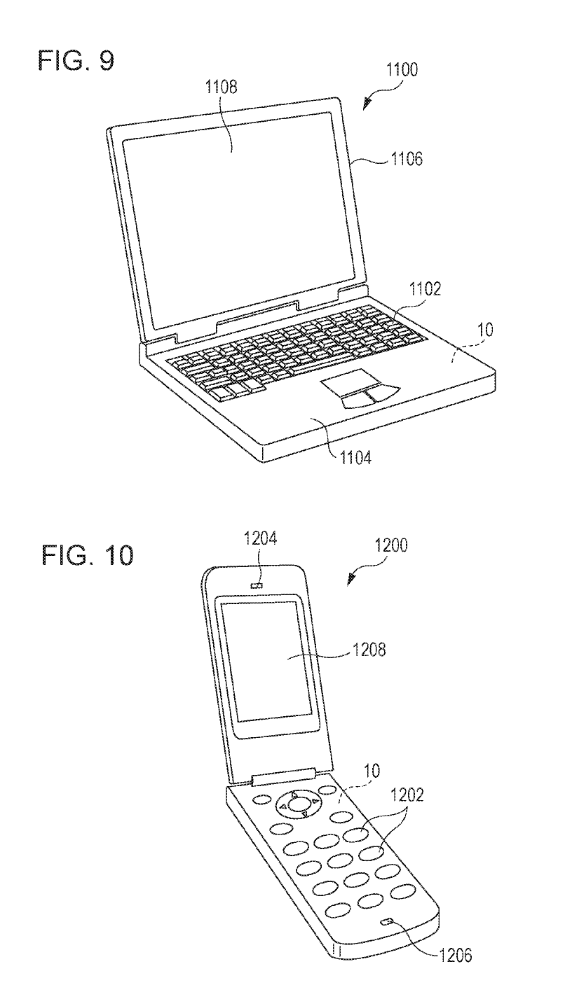

Next, an electronic apparatus using the physical quantity sensor 1 will be described in detail based on FIGS. 9 and 10.

FIG. 9 is a perspective view schematically illustrating a configuration of a mobile type personal computer as being an example of an electronic apparatus according to the invention.

In FIG. 9, the personal computer 1100 is configured with a main body 1104 including a keyboard 1102 and a display unit 1106 including a display section 1108, and the display unit 1106 is rotatably supported against the main body 1104 via a hinge structure portion. The physical quantity sensor 1 functioning as a gyro sensor is built in the personal computer 1100.

FIG. 10 is a perspective view schematically illustrating a configuration of a mobile phone as being an example of an electronic apparatus according to the invention.

In FIG. 10, the mobile phone 1200 includes a plurality of operation buttons 1202, an earpiece 1204, and a mouthpiece 1206, and a display section 1208 is disposed between the operation buttons 1202 and the earpiece 1204. The physical quantity sensor 1 functioning as a gyro sensor is built in the mobile phone 1200.

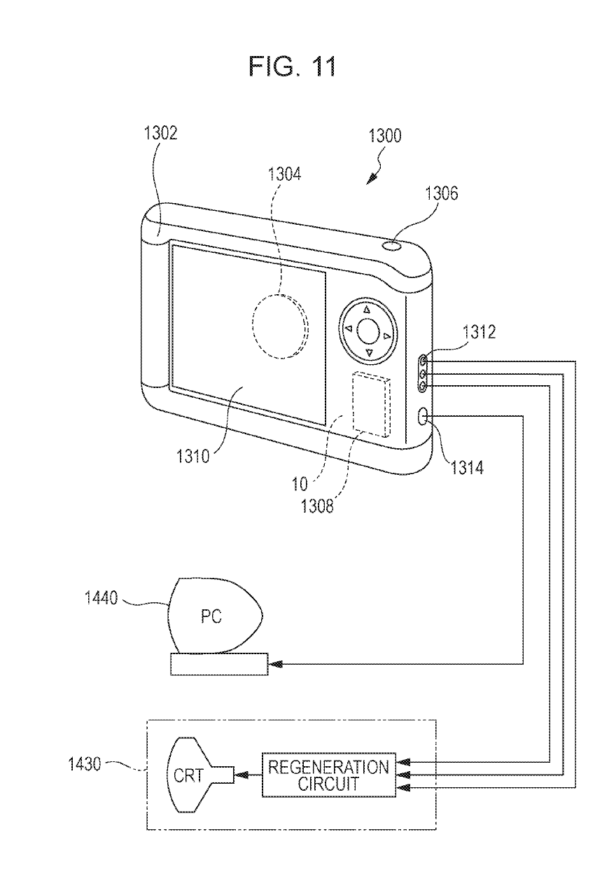

FIG. 11 is a perspective view illustrating a configuration of a digital still camera as being an example of an electronic apparatus according to the invention. In FIG. 11, connection to external apparatuses is simply illustrated. Here, a general camera exposes a silver salt photographic film to light by using an optical image of a subject, whereas the digital still camera 1300 generates an imaging signal (image signal) by photoelectric conversion on an optical image of a subject using an image pickup element such as a Charge Coupled Device (CCD).

A display section 1310 is provided at the back of a case (body) 1302 in the digital still camera 1300, and is configured to perform display based on the imaging signal obtained by the CCD. The display section 1310 functions as a viewfinder displaying the subject as an electronic image.

A light receiving unit 1304 including an optical lens (imaging optical system), CCD, or the like is provided at the front side (the back face side in FIG. 11) of the case 1302.

When a photographer confirms an image of the subject displayed on the display section and presses a shutter button 1306, the imaging signal obtained by the CCD at that time is transferred and stored in a memory 1308.

In the digital still camera 1300, video signal output terminals 1312 and an input-output terminal 1314 for data communication are provided at the side of the case 1302. As illustrated in FIG. 11, a TV monitor 1430 is connected to the video signal output terminal 1312, and a personal computer 1440 is connected to the input-output terminal 1314 for data communication, respectively, as necessary. Further, the imaging signal stored in the memory 1308 is output to the TV monitor 1430 or the personal computer 1440 by a predetermined operation.

The physical quantity sensor 1 functioning as a gyro sensor is built in the digital still camera 1300.

The electronic apparatus including the physical quantity sensor according to the invention can be applied to, for example, a smartphone, a tablet terminal, a watch, an ink jet-type discharging device (for example, an ink jet printer), a lap-top type personal computer, a television, a video camera, a video tape recorder, a car navigation device, a pager, an electronic organizer (including those having a communication function), an electronic dictionary, an electronic calculator, an electronic game device, a word processor, a workstation, a video phone, a security television monitor, a pair of electronic binoculars, a POS terminal, medical equipment (for example, an electronic thermometer, a blood pressure monitor, a blood glucose meter, an electrocardiographic measuring device, an ultrasound diagnostic device, or an electronic endoscope), a fish finder, various measurement equipment, an instrument (for example, an instrument for a vehicle, an aircraft, or a ship), a flight simulator, or the like, in addition to the personal computer illustrated in FIG. 9 (mobile type personal computer), the mobile phone illustrated in FIG. 10, and the digital still camera illustrated in FIG. 11.

### 3. Moving Object

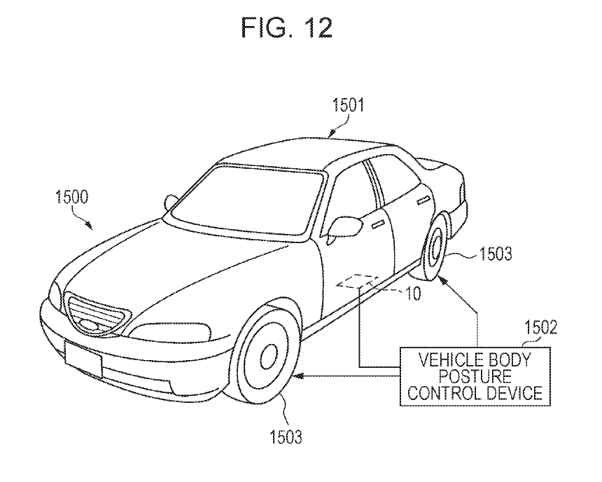

Next, a moving object using the physical quantity sensor 1 will be described in detail based on FIG. 12.

FIG. 12 is a perspective view illustrating a configuration of a vehicle as being an example of a moving object of the invention.

The physical quantity sensor 1 functioning as a gyro sensor is built in the vehicle 1500, and the physical quantity sensor 1 can detect the posture of a vehicle body 1501. A detection signal detected by the physical quantity sensor 1 is supplied to a vehicle body posture control device 1502. The vehicle body posture control device 1502 detects the posture of the vehicle body 1501 based on the signal, and controls a hardness of a suspension or a brake of an individual wheel 1503 in accordance with the detection result. In addition, the posture control can be used in a bipedal walking robot or a radio-controlled helicopter. As described above, the physical quantity sensor 1 is built in realizing a posture control of various type moving objects.

As described above, the physical quantity sensor, the electronic apparatus, and the moving object according to the invention are described based on the embodiments illustrated in the drawings. However, the invention is not limited thereto, and each of the configurations may be replaced with any configuration having a similar function. Further, any configuration may be added to the configuration of the invention.

The entire disclosure of Japanese Patent Application No. 2015-138778, filed Jul. 10, 2015 is expressly incorporated by reference herein.

What is claimed is:

1. A physical quantity sensor comprising:
a first fixed electrode side fixing portion including a first fixed electrode portion;
a second fixed electrode side fixing portion including a second fixed electrode portion;
a movable mass portion that includes a first movable electrode portion having a portion which is opposed to the first fixed electrode portion and a second movable electrode portion having a portion which is opposed to the second fixed electrode portion, and that has a shape surrounding the first fixed electrode side fixing portion and the second fixed electrode side fixing portion in a plan view;
a first movable electrode side fixing portion and a second movable electrode side fixing portion that are disposed at the outside of the movable mass portion in a plan view;
a first elastic portion connecting the first movable electrode side fixing portion and a portion of one end side of the movable mass portion in a first direction so as to allow the movable mass portion to be displaced in the first direction; and
a second elastic portion connecting the second movable electrode side fixing portion and a portion of the other end side of the movable mass portion in the first direction so as to displace the movable mass portion in the first direction.

2. The physical quantity sensor according to claim 1,
wherein the first movable electrode portion includes a plurality of first movable electrode fingers extended along a second direction intersecting with the first direction,
wherein the second movable electrode portion includes a plurality of second movable electrode fingers extended along the second direction,
wherein the first fixed electrode portion includes a plurality of first fixed electrode fingers extended along the second direction, and
wherein the second fixed electrode portion includes a plurality of second fixed electrode fingers extended along the second direction.

3. The physical quantity sensor according to claim 2,
wherein the first fixed electrode side fixing portion includes a first extension portion that is extended along the first direction and supports the plurality of the first fixed electrode fingers, and
wherein the second fixed electrode side fixing portion includes a second extension portion that is extended along the first direction and supports the plurality of the second fixed electrode fingers.

4. The physical quantity sensor according to claim 3,
wherein the first fixed electrode side fixing portion and the second fixed electrode side fixing portion are disposed side by side along the first direction,
wherein the first extension portion is extended toward the opposite side of the second fixed electrode side fixing portion, and
wherein the second extension portion is extended toward the opposite side of the first fixed electrode side fixing portion.

5. The physical quantity sensor according to claim 3,
wherein the first fixed electrode side fixing portion and the second fixed electrode side fixing portion are disposed side by side along the second direction intersecting with the first direction,
wherein the first extension portion includes a portion extended to one side in the first direction, and
wherein the second extension portion includes a portion extended to the other side in the first direction.

6. The physical quantity sensor according to claim 5,
wherein each of the first extension portion and the second extension portion includes two portions extended to one side and the other side in the first direction.

7. The physical quantity sensor according to claim 2,
wherein the movable mass portion includes weight portions which are extended toward the inside of the movable mass portion in a plan view, between the two first movable electrode fingers, between the two second movable electrode fingers, or between the first movable electrode fingers and the fixed electrode fingers, and which have a wider width than the width of the first movable electrode fingers or the second movable electrode fingers.

8. The physical quantity sensor according to claim 3, further comprising:
a substrate;
a first fixed electrode side wiring that is provided in the substrate and electrically connected to the first fixed electrode fingers; and
a second fixed electrode side wiring that is provided in the substrate and electrically connected to the second fixed electrode fingers,
wherein the first extension portion includes a portion overlapped with the first fixed electrode side wiring in a plan view, and
wherein the second extension portion includes a portion overlapped with the second fixed electrode side wiring in a plan view.

9. The physical quantity sensor according to claim 2, further comprising:
a substrate; and
movable electrode side wirings that are provided in the substrate, and electrically connected to each of the first movable electrode fingers and the second movable electrode fingers,
wherein each of tips of the first movable electrode fingers and the second movable electrode fingers overlaps with the movable electrode side wirings in a plan view.

10. The physical quantity sensor according to claim 1, further comprising:
a substrate; and
movable electrode side wirings provided in the substrate,
wherein at least one fixing portion of the first movable electrode side fixing portion and the second movable electrode side fixing portion includes a plurality of connection portions connected to the movable electrode side wirings.

11. The physical quantity sensor according to claim 10, further comprising:
contact portions with conductivity that are provided between the connection portions and the movable electrode side wirings, being in contact with the connection portions and the movable electrode side wirings.

12. The physical quantity sensor according to claim 8, further comprising:
protrusion portions that overlap with the movable mass portion in a plan view and are provided on the main face of the substrate.

13. The physical quantity sensor according to claim 1,
wherein the movable mass portion includes weight portions that are extended toward the inside of the movable mass portion in a plan view.

14. The physical quantity sensor according to claim 1, further comprising:
a substrate to which the first movable electrode side fixing portion and the second movable electrode side fixing portion are fixed,
wherein the length in the second direction of a portion in which each of the first movable electrode side fixing portion and the second movable electrode side fixing portion is fixed to the substrate is shorter than the length of the movable mass portion in the second direction.

15. The physical quantity sensor according to claim 1, further comprising:
a stopper that is provided on at least one of the first movable electrode side fixing portion and the second movable electrode side fixing portion, and regulates the amount of displacement of the movable mass portion in at least one direction of the first direction and the second direction.

16. An electronic apparatus comprising:
the physical quantity sensor according to claim 1.

17. An electronic apparatus comprising:
the physical quantity sensor according to claim 2.

18. An electronic apparatus comprising:
the physical quantity sensor according to claim 3.

19. An electronic apparatus comprising:
the physical quantity sensor according to claim 4.

20. A moving object comprising:
the physical quantity sensor according to claim 1.
